(19) United States
(12) Patent Application Publication
(10) Pub. No.: US 2013/0013408 A1
(43) Pub. Date: Jan. 10, 2013

(54) Method and Arrangement for Network Searching

(75) Inventors: Johan Hjelm, Tokyo (JP); Mattias Lidström, Stockholm (SE); Mona Matti, Nacka (SE)

(73) Assignee: TELEFONAKTIEBOLAGET LM ERICSSON (PUBL), Stockholm (SE)

(21) Appl. No.: 13/576,876

(22) PCT Filed: Feb. 22, 2010
(86) PCT No.: PCT/SE2010/050200

§ 371 Date: Aug. 23, 2012

(51) Int. Cl. G06F 17/30; G06Q 30/02

(52) U.S. Cl. 705/14.54; 707/706; 707/707

(57) ABSTRACT

A method and arrangement for supporting network searches for information or content using one or more web-based search engines. When a search query is received (1:2) from a terminal user (A), a refined search query is created (1:4) from the received query based on a user profile (104) of the user. A network search is then made (1:5) in at least one search engine (106) using the refined search query. An aggregated search result from said network search is finally delivered (1:6) in response to the received search query.

### TECHNICAL FIELD

The invention relates generally to a method and arrangement for supporting searches for information and content over a communication network in order to obtain more relevant search results.

### BACKGROUND

Recently, much development has been directed to improve the process of network searching by means of a search engine, i.e. using a communication network such as the Internet when searching for information or content typically presented in web pages or the like. A search engine is designed to search for information on the Internet, or “World Wide Web”. Several well-known and quite powerful search engines and tools are available today, e.g. Google and Yahoo. In this description, the term “network searching” will be used to represent any searching for information and content over a communication network, typically the Internet, by means of a search engine.

A terminal user can thus provide one or more search terms as input in a search query to any of these search engines, which then executes the search by propagating the terms through the network in search for matches in files, web pages, etc., being stored at various servers or nodes connected to the network. The search engine then presents the search results to the terminal user as a list of results, often referred to as hits and typically comprising links to web pages or other files. The web pages or other files holding information and content at such nodes in the network are generally referred to as “resources”.

Typically, a resource can be associated with a set of predefined keywords forming an index, which are used to speed up the search operation. The contents of each resource can be analyzed to determine how it should be indexed by means of keywords. For example, words of particular significance can be extracted from the titles, headings, or special fields called “meta tags”, to provide the index with keywords. Data about web pages and files may then be stored in an index database for use in later queries. The purpose of using an index and/or keywords is to facilitate the search and allow information to be found with a minimum of delay.

A search query can be comprised of a single word or a combination of words forming a search string or the like. When a user inputs a query into a search engine, typically in the form of one or more search terms, the search engine examines its indices and provides a result list of the best-matching resources such as web pages and files, according to the search query, usually with a short summary containing a title of the resource and sometimes also a limited part of a text of the hit.

Most search engines also support the use of Boolean operators such as AND, OR and NOT to further specify the search query. Boolean operators thus allow the user to refine and extend the search criteria. Typically, the search engine primarily looks for the words or phrases exactly as entered. Some search engines may also provide an advanced feature called “proximity search” allowing users to specify a maximum distance between keywords. Furthermore, natural language queries allow users to input a query basically as phrased in human talk.

From the users' perspective, the value of web or Internet searching is largely dependent on the relevance of the search results returned. While there may be millions of web pages that include a particular word or phrase given in a search query, some pages may naturally be more relevant, popular or trustworthy than others. Most search engines have mechanisms for ranking the results to provide the “best” results first. How a search engine decides which resources are the best matches, and in what order the results should be presented, varies widely from one engine to another. In this respect, there are two main types of search engines that have evolved: one is a system of predefined and hierarchically ordered keywords that humans have programmed extensively. The other is a system that generates an “inverted index” by analyzing texts it has found.

Many companies operating search engines can earn money by presenting search related advertisements to the users in addition to the regular search results. Search engines are often supported by advertising parties and some even employ the practice of allowing advertisers to pay for having their listings ranked higher in the search results. The search engine operation companies are then able to get revenue each time someone clicks on one of these advertisements.

A so-called “metasearch engine” may also be employed as a portal or the like for network searching that sends search queries from users to other search engines and/or databases and aggregates the results into a single result list. The metasearch engine thus enables users to basically enter a search query once and access multiple search engines simultaneously.

Still, the relevance of search results is often not satisfactory, mainly since words and search strings entered in the queries are often ambiguous and can have several different meanings, e.g. in different contexts. The search engine is not able to determine what meaning the user has intended with his/her entered words. The keywords or indices associated to the resources may also be more or less ambiguous, indefinite or even confusing, frequently resulting in irrelevant hits. Given the vast and ever increasing amounts of information and content available on the Internet, the problem of irrelevant search results becomes more and more accentuated and the search engines are unable to improve their search methods any further in this respect.

Another problem is that queries with one or only a few keywords or very short phrases will produce a great number of hits of seemingly equal significance. For example, if a mobile phone with limited input and display means is used for making search queries, the users will probably be inclined to enter only short hasty queries which as a result can be more or less ambiguous or indefinite.

### SUMMARY

It is an object of the invention to address at least some of the problems and issues outlined above. It is also an object to provide more relevant search results in response to search queries. It is possible to achieve these objects and others by using a method and an arrangement as defined in the attached independent claims.

According to one aspect, a method is provided for supporting network searches for information or content over a communication network using one or more web-based search engines. In this method, when a search query made by a terminal user is received, a refined search query is created from the received search query based on information related to the user. This user-related information comprises at least one of: user data related to personal characteristics or preferences of the user, context data related to the current situation of the user, and search history data related to previous searches made by the user. A network search is then made by sending the refined search query to at least one search engine and receiving a search result from each search engine. An aggregated search result from the network search can then be delivered in response to the received search query. In this way, the search can be made more apt and efficient as compared to a conventional search.

According to another aspect, an arrangement is provided that is configured to support network searches for information or content over a communication network using one or more web-based search engines. The network search provider comprises a receiving module adapted to receive a search query made by a terminal user, and a query module adapted to create a refined search query from the received search query, based on information related to the user. As in the method, the user-related information comprises at least one of: user data related to personal characteristics or preferences of the user, context data related to the current situation of the user, and search history data related to previous searches made by the user. The network search provider also comprises a search module adapted to make a network search, by sending the refined search query to at least one search engine and receiving a search result from each search engine, and a delivery module adapted to deliver an aggregated search result from the network search in response to the received search query.

The above method and arrangement may be configured and implemented according to different embodiments. In one embodiment, at least one of the user data, context data and search history data is maintained in a user profile for the terminal user. A plurality of refined search queries may also be created, each being adapted to the capability or characteristics of a particular search engine, and each refined search query can then be provided as input to the corresponding search engine in the network search. The at least one search engine may be selected for searching based on the user-related information.

The user data may further relate to any of: the age, gender, profession or interests of the user, while the context data may further relate to any of: the current position, settings or terminal capabilities of the user.

In a possible implementation, a metasearch engine may be used to receive the search query, execute the network search and deliver the search result, while a recommender engine may be used to create the refined search query. The metasearch engine, the recommender engine, and the at least one search engine may be configured to form a peer-to-peer overlay network. Further, the metasearch engine may also create and maintain the search history data by registering the user's executed network searches.

In further possible embodiments, search results from plural search engines are aggregated based on the user-related information, to form the aggregated search result. Advertisements may be received with the search result from the search engine(s) and/or obtained from an advertisement server, and a number of the advertisements can then be selected for delivery with the aggregated search result, based on the user-related information. The aggregated search result may also be analysed and used for updating the user profile.

Further possible features and benefits of this solution will become apparent from the detailed description below.

### BRIEF DESCRIPTION OF DRAWINGS

The invention will now be described in more detail by means of exemplary embodiments and with reference to the accompanying drawings, in which:

FIG. 1 is a schematic block diagram illustrating a communication scenario for network searching, according to one possible embodiment.

FIG. 2 is a flow chart with steps performed by a network search provider when implemented in one or more network nodes, according to further exemplary embodiments.

FIG. 3 is a signalling diagram illustrating an example of how the invention can be put into practice, according to another possible embodiment.

FIG. 4 is a block diagram illustrating in more detail a network searching arrangement, according to further exemplary embodiments.

### DETAILED DESCRIPTION

Briefly described, a solution is provided to obtain a more effective and apt process of searching for information or content on a communication network such as the Internet, by taking the querying user into account. This solution is based on various information related to the user, e.g. information on the current situation of the user, which may be stored and maintained in a user profile or the like. Whenever a search query is received from the user, a refined search query is created from the received query based on the information regarding the user. The refined search query is then used in a network search involving one or more search engines, and the search results received from the search engine(s) are used to create an aggregated search result which is delivered in response to the received search query.

Thereby, the words and/or phrases in the user's search query can be interpreted with respect to the user-related information and the query can be expanded accordingly, to create a refined search query that is more to the point and relevant for the circumstances of that particular user. For example, the refined search query may be created depending on his/her current situation as well as device capabilities and settings. In this description, the above factors are generally referred to as the user's current “context”. The refined search query may further be based on personal characteristics and preferences of the user, here generally referred to as “user data”, and a search history, i.e. the user's previously executed network searches.

A plurality of such refined search queries may be created, which are adapted to the capabilities or characteristics of plural individual search engines, and each refined search query is then used in the network search as input to the corresponding search engine.

In this description, the term “search engine” is used to represent any existing available service entity capable of providing searches on a communication network such as the Internet. Further, a “user profile” refers to a documented collection of information related to the user, e.g. as exemplified above, which may be stored and maintained in a user database or the like, herein generally called a “profile storage”. The “user-related information” could be any of the above-described context data, user data and search history data.

An exemplary procedure and arrangement for making a network search for information or content over a communication network, will now be described with reference to FIG. 1. In this figure, a user “A” operates a communication terminal 100 such as a computer or telephone, to make a search for information or content over a public network such as the Internet. A “network search provider” 102 is schematically illustrated which is capable of supporting the network search in the following manner. The network search provider 102 may comprise one or more actual nodes and its operation may be implemented in different ways, e.g. in a metasearch engine and a recommender engine, which will be described in more detail later below.

In FIG. 1, schematic first actions 1:1a, 1:1b and 1:1c illustrate that user profiles 104 are created and maintained for different users from user-related information including at least one of: user data, context data and search history data, respectively. The user data may relate to, without limitation, any of: the age, gender, profession or interests of the user. Further, the search history data may relate to the user's previously executed network searches, e.g. including which hits in a result list the user has clicked on. Alternatively, the user data, context data and search history data may be stored separately, i.e. not necessarily collected in a single joint profile.

This user-related information may be obtained from different suitable information sources, depending on the implementation, e.g. from subscription databases, presence servers, metasearch engines, or even from the user himself/herself, and the invention is generally not limited to any specific information sources or combination of information types. Furthermore, the above actions of collecting user-related information for building a user profile or the equivalent could be an ongoing continuous process for keeping each user profile up-to-date which is performed “in the background” and independent of the following shown actions. In particular, the context data referring to a user may be changed dynamically as the situation of the user changes, e.g. his/her current position and terminal usage and settings.

A next action 1:2 illustrates that user A sends a search query to the network search provider 102. The search query may comprise one or more “potentially” ambiguous or indefinite search terms, and it may not be readily understood what the user has actually in mind with those search terms and what kind of search results he/she is expecting. Therefore, the network search could be ineffective and misleading if the search query is used in its original form by a search engine, as described in the background section above.

In this solution, the above potential shortcomings of the original search query may be overcome by modifying the query, before making the search, taking the user-related information in the user's profile into account. A next action 1:3 thus illustrates that the user profile 104 of user A is retrieved and considered by the network search provider 102. For example, the user profile 104 of A may be stored and maintained along with other user profiles in a user database that can be accessed by search provider 102, or in a local storage at the search provider 102, depending on the implementation.

In a following action 1:4, a refined search query is created from the received original query based on the user profile 104. Expressed differently, the received search query is modified or expanded into a refined search query in consideration of the user profile 104. The refined search query may thus be an expansion of the original one, taking the user-related information in profile 104 into account. For example, synonyms to original search terms may be added, or a search string may be expanded or otherwise clarified to become more unambiguous than the original one. The network search provider 102 has a suitable logic function, e.g. implemented in a recommender engine or the like, that is capable of extracting a presumably accurate interpretation of the received original query and of creating the refined search query accordingly, on the basis of the user-related information in profile 104.

In one hypothetical example, a user may input the ambiguous search term “suit” in the original search query. The network search provider 102 may then refine the query by adding the term “clothing” to form a refined query, knowing from context data in the user profile that the user is currently located in a shopping area, and thereby assuming that the user is not primarily interested in law suits nor apartments at the moment. In another situation, the search term “seal” would be interpreted, based on context information saying that the user is present in a zoo, as the animal rather than a closure element or a waxed seal or a statesman's seal.

The network search provider 102 then sends the refined search query to one or more search engines 106, in a further action 1:5. In this action, each search engine 106 executes a regular network search using the terms in the refined search query in search for matches, basically in a conventional manner. Each search engine 106 returns a search result to search provider 102 and the latter aggregates them into an aggregated search result, which is finally delivered to the terminal 100 of user A in a last action 1:6.

The above-described procedure and arrangement can be modified or implemented optionally in various ways. For example, advertisements may also be received with the search result from the search engine(s) in action 1:5, e.g. depending on the operation of the search engines used. Advertisements relating to the refined search query may also be obtained from an advertisement server, not shown. A number of the advertisements may then be selected for delivery with the aggregated search result, based on the user-related information in the user profile, which will be further described later below.

The search results from the one or more search engines 106 can also be aggregated in different ways. For example, search results from plural search engines may be aggregated based on the user-related information, to form the aggregated search result. Further, all duplicates of hits are preferably eliminated, and the selection and/or order of hits in a hit list to be presented may be determined, e.g., depending on which search engine the hits come from, or depending on certain user data, context data or search history data in the user profile. In other words, the search results obtained in action 1:5 may be filtered according to various filter criteria, e.g. relating to the user-related information in the user profile.

Any search engine(s) 106 may be used in action 1:5 and the invention is not limited in this respect. Optionally, a plurality of different refined search queries may be created in action 1:4, where each refined search query is adapted to the capability or characteristics of a particular search engine. The different refined search queries are then provided as input to corresponding search engines in the network search. In this way, it is possible to distribute the load of executing the search among multiple search engines to make the search more effective, which could be referred to as “load balancing”.

Furthermore, one or more of the search engines can be selected for searching depending on the user-related information in the user profile. Thus, some search engines may be more suitable than others to execute a search for the user, e.g. depending on his/her current situation as stated in context data of the profile and further possibly depending on the capability or characteristics of each search engine.

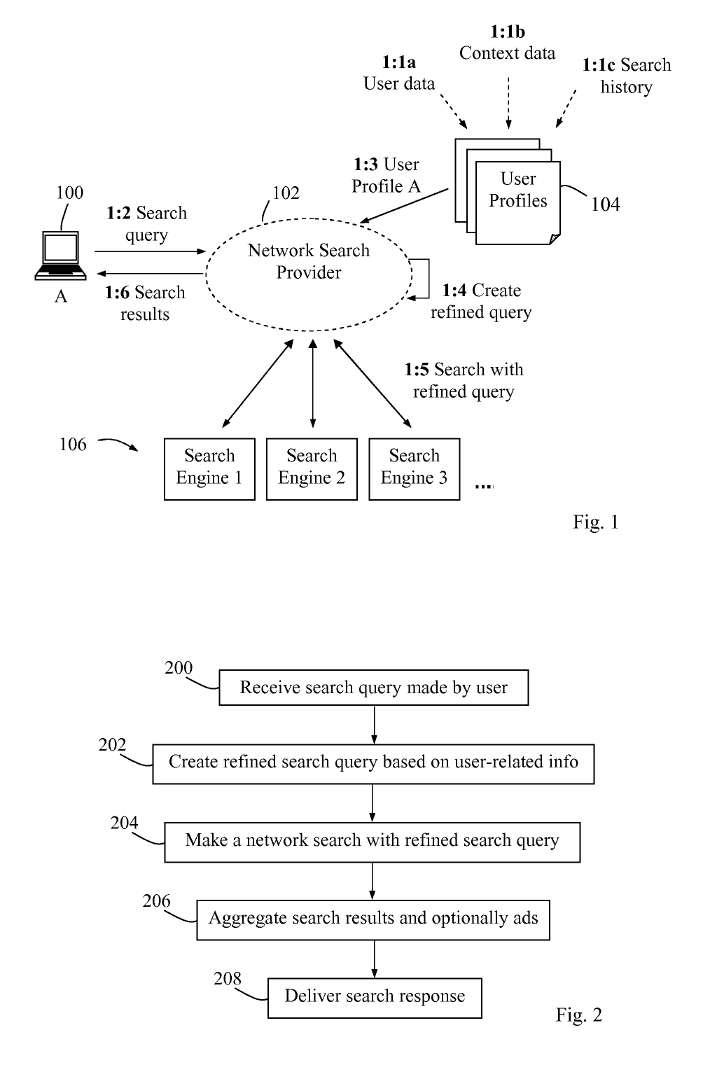

An exemplary procedure for supporting network searches for information or content over a communication network, using one or more web-based search engines, will now be described with reference to the flow chart in FIG. 2. The shown steps may be executed by a network search provider or the equivalent, as described above for FIG. 1. In a first step 200, a search query made by a terminal user is received, basically corresponding to action 1:2 above. Depending on the implementation, the search query may be received directly from a communication terminal operated by the user, or from a user agent serving the user, which may be connected to the network search provider in a peer-to-peer overlay network that may also include at least one search engine. The user agent is a known application that can be implemented in the user's terminal or in another node operating on behalf of the user.

A refined search query is then created from the received search query based on information related to the user, in a next step 202, basically corresponding to action 1:4 above. As in the above-described example, the user-related information comprises at least one of: user data related to personal characteristics or preferences of the user, context data related to the current situation of the user, and search history data related to previous searches made by the user. The user-related information may be documented in a user profile or the equivalent, which is retrieved for making the above refined search query.

In a further step 204, a network search is made by sending the refined search query to at least one search engine, and a search result is received from each search engine, basically corresponding to action 1:5 above. A next step 206 illustrates that the search results received from the search engine(s) in the network search are aggregated into an aggregated search result, optionally also including advertisements that have been selected for delivery, based on the user-related information in the user profile. The aggregated search result, together with selected advertisements if applied, is finally delivered in response to the received search query, in a last step 208.

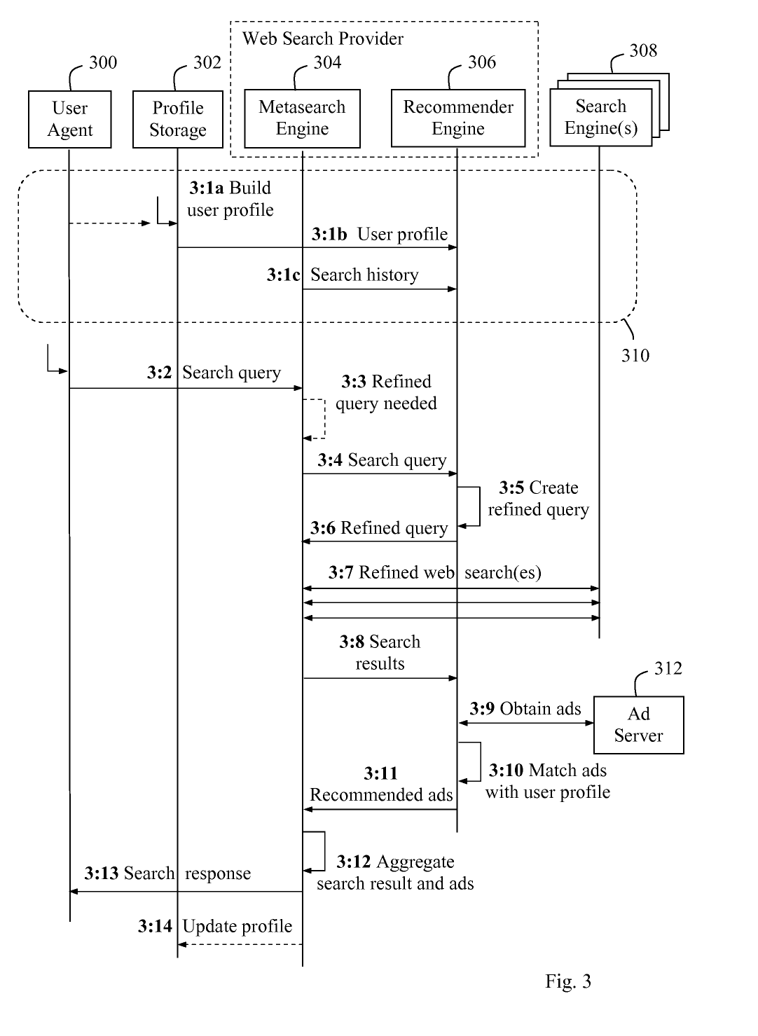

An example of how the inventive solution can be implemented in practice will now be described with reference to the signalling diagram in FIG. 3, involving a user agent 300 serving a terminal user, a profile storage 302 holding a user profile with user-related information, a metasearch engine 304, a recommender engine 306 and a plurality of search engines 308. The metasearch engine 304 and the recommender engine 306 is a possible implementation of the above-described network search provider, configured to operate as described in the previous examples. In brief, metasearch engine 304 operates to handle search queries to or from the user while recommender engine 306 operates to create refined search queries, to be further described below. The metasearch engine 304, the recommender engine 306 and the search engines 308 preferably form a peer-to-peer overlay network such that the communication between these nodes can easily be made using a peer-to-peer protocol which does not require the involvement of any central control node of a service network or the like.

The procedure illustrated in this figure includes a preparation phase 310 involving a first step 3:1a of building a user profile in profile storage 302, which can basically be done as described above for actions 1:1a-c of collecting user-related information including at least one of: user data, context data and search history data. As mentioned above, the user-related information may be obtained from one or more servers holding such information or by input from the user, as schematically illustrated by a dashed arrow from user agent 300.

A next step 3:1b in the preparation phase 310 illustrates that the user profile in profile storage 302 is somehow provided to the recommender engine 306, e.g. on a subscription basis or upon request by the engine 306. Alternatively, engine 306 may fetch the user profile when needed for creating a refined query. The shown preparation phase 310 includes another possible step 3:1c where the metasearch engine 304 also provides a search history to the user to the recommender engine 306, which likewise can be done on a subscription basis or upon request by the engine 306.

The following and remaining steps in the shown procedure are made in a “run-time phase”, i.e. when a network search is to be performed for the user. The steps 3:1a-c of the preparation phase 310 may be made more or less independent of the following run-time phase steps, e.g. as an ongoing continuous process for keeping the user profile, that is the user-related information, up-to-date. Thus, a next step 3:2 illustrates that metasearch engine 304 receives a search query, made by the terminal user, from user agent 300. As in the above examples, the received query is potentially ambiguous or indefinite, not clearly indicating what the user has in mind and what kind of search results he/she is expecting. The metasearch engine 304 may use a logic function for deciding whether a refined search query is needed or not due to ambiguous or indefinite original query, as indicated by a dashed step 3:3, however being somewhat outside the scope of this solution.

In a further step 3:4, metasearch engine 304 accordingly forwards the received original search query to the recommender engine 306 for refinement. Engine 306 thus creates a refined search query from the received search query based on user-related information, in another step 3:5, which it has received in the user profile in step 3:1b above. Alternatively, the recommender engine 306 may retrieve the user-related information from profile storage 302 in response to receiving the original search query in step 3:4, for refinement. The refinement operation has been described in more detail above, which is not necessary to repeat here.

In a next step 3:6, the recommender engine 306 then provides the refined search query to metasearch engine 304, which in turn makes a network search by sending the refined search query to the search engines 308, or to at least one of them, and accordingly receives a search result from each search engine, as illustrated by a joint step 3:7.

In this example, the obtained search results are provided to the recommender engine 306, in a step 3:8, for finding appropriate advertisements that can be delivered to the user later on, together with search results. Accordingly, a next step 3:9 illustrates schematically that the recommender engine 306 obtains advertisements from an advertisement server 312 or the equivalent, which are selected as relating to the refined search query in some way. Presumably, the selected advertisements would then be of some interest to the user having made the original search query from which the refined search query was created. In practice, this step may be implemented such that recommender engine 306 sends an advertisement request or the like referring to the refined search query, e.g. to one or more significant terms in the query. Alternatively or additionally, advertisements may also be included in the search responses received from the search engines 308 is step 3:7.

In a further step 3:10, the recommender engine 306 matches the obtained advertisements with the user profile, in an attempt to further adapt the selection of advertisements to the user. The matching of advertisements with the search terms used may also be made in this step. The recommender engine 306 then provides a set of recommended advertisements to metasearch engine 304, in a further step 3:11, and engine 304 is then able to aggregate the search results from the search engines 308 as well as the recommended advertisements, to form an aggregated search result, in a following step 3:12. This aggregation may further be based on the user-related information in the user profile.

Eventually, a search result can be delivered back to the user agent 300 in a step 3:13, in response to the original search query of step 3:2. A further dashed step 3:14 illustrates that the metasearch engine may optionally update the search history data in the user profile in storage 302, by registering the user's just executed network search. In general, the metasearch engine 304 may create and maintain search history data in profile storage 302 by registering network searches executed by corresponding users, more or less on a continuous basis. In particular, it may be registered which hits in a result list a user has clicked on, i.e. showing some interest thereof.

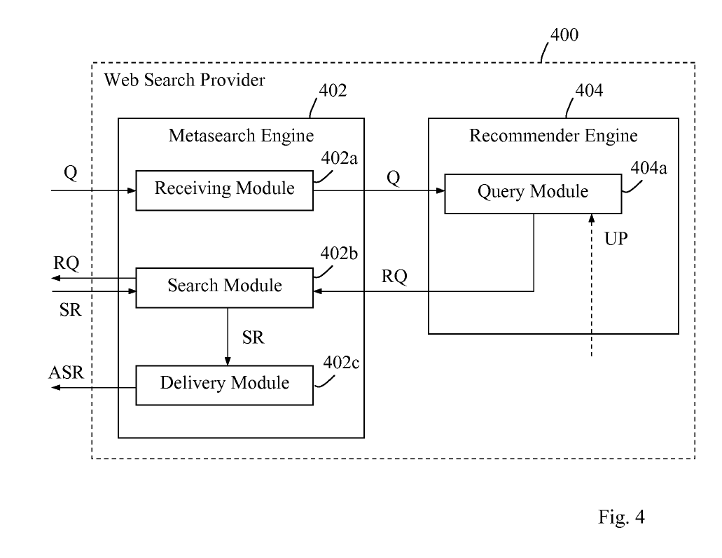

An arrangement in a network search provider will now be described in more detail with reference to the block diagram of FIG. 4. The network search provider 400 is configured to support network searches for information or content over a communication network using one or more web-based search engines. The network search provider 400 may be used to accomplish any of the above-described procedures and embodiments. The various functions therein are called “modules” in this description, although they could also be seen as units, blocks, elements or components.

In the arrangement shown in FIG. 4, the network search provider 400 is logically divided into a metasearch engine 402 and a recommender engine 404 which could be implemented in two separate communicating nodes as in the example of FIG. 3, or in a single node. In one possible implementation, the metasearch engine 402 and the recommender engine 404, may form a peer-to-peer overlay network with one or more search engines, as described above. However, the illustrated functional modules may also be implemented as a united or joint “engine” or the like.

According to the shown configuration, the metasearch engine 402 comprises a receiving module 402a adapted to receive a search query Q made by a terminal user, not shown here. The recommender engine 404 comprises a query module 404a adapted to create a refined search query RQ from the received search query, based on information UP related to the user. The user-related information UP comprises at least one of: user data related to personal characteristics or preferences of the user, context data related to the current situation of the user, and search history data related to previous searches made by the user.

The metasearch engine 402 also comprises a search module 402b adapted to make a network search, by sending the refined search query RQ to at least one search engine, not shown here, and receiving a search result SR from each search engine. Engine 402 finally comprises a delivery module 402c adapted to deliver an aggregated search result ASR from the network search, in response to the received search query.

The query module 404a may be further adapted to create a plurality of refined search queries, each being adapted to the capability or characteristics of a particular search engine, and where each refined search query is provided as input to the corresponding search engine in the network search. The metasearch engine 402 may be adapted to create and maintain the search history data by registering the user's executed network searches.

Further, the search module 402b may be adapted to form the aggregated search result by aggregating search results from plural search engines based on the user-related information. The network search provider 400 may also be configured to receive advertisements with the search result from the search engine(s), e.g. at the search module 402b, and/or to obtain advertisements from an advertisement server (not shown), and to select a number of the advertisements for delivery with the aggregated search result, based on the user-related information. The recommender engine 404 may be configured to communicate with the advertisement server and to return recommended advertisements to the metasearch engine 402, e.g. in the manner described for steps 3:9-3:11 above.

It should be noted that FIG. 4 merely illustrates various functional units or modules in the network search provider 400 in a logical sense, although the skilled person is free to implement these functions in practice using suitable software and hardware means. Thus, the invention is generally not limited to the shown structures of the entities 400, 402 and 404, respectively, while its functional modules 402a-c and 404a may be configured to operate according to the methods and procedures described above for FIGS. 1-3, where appropriate.

When using the invention, e.g. according to any of the embodiments described above, the network searches can be made more to the point, apt and efficient. By using a user-based refined search query which is distributed to one or more search engines, the search results therefrom will be potentially more relevant to that particular user and the load on each search engine will at the same time be reduced. Furthermore, the searches can produce a more limited number of hits in the delivered search result, which may be valuable and helpful to the user.

While the invention has been described with reference to specific exemplary embodiments, the description is generally only intended to illustrate the inventive concept and should not be taken as limiting the scope of the invention. The invention is defined by the appended claims.

1-18. (canceled)

19. A method of supporting network searches for information or content over a communication network using one or more web-based search engines, comprising the following steps, performed by a Network Search Provider:
receiving a search query made by a terminal user,
creating a refined search query from the received search query based on information related to said terminal user comprising at least one of: user data related to personal characteristics or preferences of the user, context data related to the current situation of the user, and search history data related to previous searches made by the user,
making a network search, by sending the refined search query to at least one search engine, and receiving a search result from each search engine, wherein search results from plural search engines are aggregated based on user-related information, to form an aggregated search result, and
delivering the aggregated search result from said network search, in response to the received search query.

20. The method according to claim 19, wherein at least one of said user data, context data and search history data is maintained in a user profile for said terminal user.

21. The method according to claim 19, wherein a plurality of refined search queries are created, wherein each refined search query is provided as input to the corresponding search engine in said network search.

22. The method according to claim 19, wherein the at least one search engine is selected for searching based on said user-related information.

23. The method according to claim 19, wherein the user data further relates to any of the age, gender, profession or interests of said user.

24. The method according to claim 19, wherein the context data further relates to any of the current position, settings or terminal capabilities of said user.

25. The method according to claim 19, wherein the network search provider is logically divided into a metasearch engine and a recommender engine, and the steps of receiving the search query, executing the network search and delivering the search result are performed by the metasearch engine, while the step of creating the refined search query is performed by the recommender engine.

26. The method according to claim 25, wherein the metasearch engine, the recommender engine, and the at least one search engine form a peer-to-peer overlay network.

27. The method according to claim 25, wherein the metasearch engine creates and maintains said search history data by registering said user's executed network searches.

28. The method according to claim 19, wherein advertisements are acquired from at least one of the search result from the one or more search engine and obtained from an advertisement server, and a number of said advertisements are selected for delivery with the aggregated search result, based on said user-related information.

29. The method according to claim 20, wherein the aggregated search result is analysed and used for updating the user profile.

30. An arrangement in a network search provider configured to support network searches for information or content over a communication network using one or more web-based search engines, wherein the network search provider comprises:
a receiving module adapted to receive a search query made by a terminal user,
a query module adapted to create a refined search query from the received search query, based on information related to said terminal user comprising at least one of: user data related to personal characteristics or preferences of said user, context data related to the current situation of said user, and search history data related to previous searches made by said user,
a search module adapted to make a network search, by sending the refined search query to at least one search engine, by receiving a search result from each search engine, and by forming an aggregated search result by aggregating search results from plural search engines based on said user-related information, and
a delivery module adapted to deliver an aggregated search result from the network search in response to the received search query.

31. The arrangement according to claim 30, wherein the query module is further adapted to create a plurality of refined search queries, where each refined search query is provided as input to the corresponding search engine in said network search.

32. The arrangement according to claim 30, wherein said arrangement is further configured to select the at least one search engine for searching based on said user-related information.

33. The arrangement according to claim 30, wherein the network search provider is logically divided into a metasearch engine and a recommender engine, and the receiving module, the search module and the delivery module are implemented as the metasearch engine, while the query module is implemented as the recommender engine.

34. The arrangement according to claim 33, wherein the metasearch engine, the recommender engine, and the at least one search engine form a peer-to-peer overlay network.

35. The arrangement according to claim 33, wherein the metasearch engine is adapted to create and maintain said search history data by registering the user's executed network searches.

36. The arrangement according to claim 30, wherein said arrangement is further configured to perform at least one of the following: receive advertisements with the search result from the at least one search engine; and obtain advertisements from an advertisement server, the arrangement further configured to select a number of said advertisements for delivery with the aggregated search result, based on said user-related information.
